(19) United States
(12) Patent Application Publication
(10) Pub. No.: US 2026/0016866 A1
(43) Pub. Date: Jan. 15, 2026

(54) FOLDABLE ELECTRONIC DEVICE

(71) Applicant: SYNCMOLD ENTERPRISE CORP., New Taipei City (TW)

(72) Inventors: Ching-Hui Yen, New Taipei City (TW); Chien-Cheng Yeh, New Taipei City (TW); Chun-Hao Huang, New Taipei City (TW)

(21) Appl. No.: 19/208,828

(22) Filed: May 15, 2025

Related U.S. Application Data
(60) Provisional application No. 63/670,373, filed on Jul. 12, 2024.

(30) Foreign Application Priority Data
Feb. 20, 2025 (TW) 114106308

(51) Int. Cl. G06F 1/16

(52) U.S. Cl. CPC G06F 1/1681; G06F 1/1616; G06F 1/1652

(57) ABSTRACT

A foldable electronic device is provided and comprises: a central base, a pivot module, two wing members, two transmission members, two panel bodies, two drop plates, two connecting rods, a synchronization module, an elastic module and a flexible screen. The pivot module is disposed in the central base. The wing members pivot relative to the central base. The transmission members are connected to the pivot module, the synchronization module and the elastic module. The panel bodies are connected to the wing members. The drop plates are connected to the panel bodies. The connecting rods are connected to the transmission members and the drop plates. The synchronization module drives the transmission members to rotate reversely and synchronously. The flexible screen is disposed on the central base, the panel bodies and the drop plates and includes a bendable area.

### CROSS-REFERENCE TO RELATED APPLICATIONS

This application claims the benefit of U.S. Provisional Application Ser. No. 63/670,373 filed on Jul. 12, 2024, and the benefit of Taiwan Patent Application Serial No. 114106308 filed on Feb. 20, 2025. The entirety of each Application is incorporated herein by reference.

### BACKGROUND

### 1. Technical Field

The present disclosure relates to a foldable electronic device, and more particularly, to a foldable electronic device with a flexible screen.

### 2. Description of Related Art

Flexible screens have been widely applied in smartphones and tablets computers. If a structure for supporting the flexible screen is not well designed, a bendable area of the flexible screen may be damaged when folded, or the flexible screen may not be completely flattened when unfolded, which may cause troubles to users. In addition, there are conventional linkage structures providing required accommodation spaces for the bendable areas, but sizes and angles of the accommodation spaces formed are fixed during folding of the conventional linkage structures. However, deformation amounts and shapes of different flexible screens during folding may be inconsistent, resulting in mismatching between the accommodation spaces and correspondingly original designs.

### SUMMARY

The present disclosure provides a foldable electronic device, which comprises: a central base including a body portion, a track portion, at least one first inner arc-shaped slider and at least one second inner arc-shaped slider, wherein the track portion extends outward from the body portion, and the first inner arc-shaped slider and the second inner arc-shaped slider are respectively formed on the body portion and spaced apart from each other; a pivot module disposed on the central base and including a first shaft and a second shaft respectively pivotally connected to the body portion; a first wing member including at least one first inner arc-shaped slideway and a first pivot portion, wherein the first inner arc-shaped slider is slidably disposed on the first inner arc-shaped slideway, whereby the first wing member is able to pivot relative to the body portion with a first inner virtual axis as a center; a first transmission member sleeved on the first shaft and including a first bottom rod; a first panel body including a first carrying member, the first carrying member having a first pivoting part and a first straight slide groove, wherein the first pivoting part is pivotally connected to the first pivot portion and jointly define a first outer virtual axis, whereby the first carrying member is able to rotate relative to the first wing member about the first outer virtual axis, and the first transmission member is slidably disposed in the first straight slide groove, whereby the first carrying member is able to slide linearly relative to the first transmission member; a first drop plate pivotally carried on the first carrying member; a first connecting rod pivotally connected to the first drop plate and including a first elongated slide groove, wherein the first bottom rod is slidably disposed in the first elongated slide groove, so that a first degree of freedom is formed thereof; a second wing member including at least one second inner arc-shaped slideway and a second pivot portion, wherein the second inner arc-shaped slider is slidably disposed on the second inner arc-shaped slideway, whereby the second wing member is able to pivot relative to the body portion with a second inner virtual axis as a center; a second transmission member sleeved on the second shaft and including a second bottom rod; a second panel body including a second carrying member, the second carrying member having a second pivoting part and a second straight slide groove, wherein the second pivoting part is pivotally connected to the second pivot portion and jointly define a second outer virtual axis, whereby the second carrying member is able to rotate relative to the second wing member about the second outer virtual axis, and the second transmission member is slidably disposed in the second straight slide groove, whereby the second carrying member is able to slide linearly relative to the second transmission member; a second drop plate pivotally carried on the second carrying member; a second connecting rod pivotally connected to the second drop plate and including a second elongated slide groove, wherein the second bottom rod is slidably disposed in the second elongated slide groove, so that a second degree of freedom is formed thereof; a synchronization module including a synchronization slider body slidably disposed between the first transmission member and the second transmission member, wherein the first transmission member and the second transmission member are respectively connected to the synchronization slider body, and wherein the synchronization slider body is able to drive the first transmission member and the second transmission member to rotate synchronously and reversely, respectively, when the synchronization slider body slides; an elastic module including a pushing member, wherein the pushing member is slidably sleeved on the first shaft and the second shaft and movably engaged with the first transmission member and the second transmission member; and a flexible screen disposed on the first panel body, the second panel body, the first drop plate, the second drop plate and the central base, and including a bendable area; wherein the first panel body and the second panel body are able to change between an unfolded state and a folded state, wherein when the first panel body and the second panel body are in the unfolded state, the flexible screen is flattened, and the first drop plate, the second drop plate, and the central base jointly support the bendable area, wherein when the first panel body and the second panel body are in the folded state, the bendable area of the flexible screen is bent, the first drop plate, the second drop plate and the central base jointly define an accommodation space to accommodate the bendable area, and wherein a free angle between the first drop plate and the second drop plate is formed by cooperating of the first degree of freedom and the second degree of freedom, and the free angle is able to vary in size according to a bending degree the bendable area.

In the aforementioned foldable electronic device, the first elongated slide groove has a first head end and a first tail end opposite each other, the second elongated slide groove has a second head end and a second tail end opposite each other, when the first panel body and the second panel body are in the unfolded state, the first bottom rod abuts against the first head end, and the second bottom rod abuts against the second head end, wherein when the first panel body and the second panel body are in a half-folded state between the unfolded state and the folded state, the first bottom rod abuts against the first tail end, and the second bottom rod abuts against the second tail end, and wherein when the first panel body and the second panel body are in the folded state, the first bottom rod is located between the first head end and the first tail end, allowing the first degree of freedom to be formed, and the second bottom rod is located between the second head end and the second tail end, allowing the second degree of freedom to be formed.

In the aforementioned foldable electronic device, the first drop plate includes a first outer arc-shaped slider and a first top rod, the first carrying member further has a first outer arc-shaped slideway, and the first outer arc-shaped slider is slidably disposed on the first outer arc-shaped slideway, the first connecting rod further includes a first through hole spaced apart from the first elongated slide groove, and the first top rod inserts through the first through hole, the second drop plate includes a second outer arc-shaped slider and a second top rod, the second carrying member further has a second outer arc-shaped slideway, and the second outer arc-shaped slider is slidably disposed on the second outer arc-shaped slideway, and wherein the second connecting rod further includes a second through hole spaced apart from the second elongated slide groove, and the second top rod inserts through the second through hole.

In the aforementioned foldable electronic device, the first shaft extends along a first axis, and the first straight slide groove extends substantially perpendicular to the first axis, wherein the first transmission member further includes a first bending plate and a first straight slider, the first bending plate extends along a radial direction of the first axis and is bent, the first straight slider extends outward from the first bending plate along the radial direction of the first axis and is slidably disposed in the first straight slide groove, and the first bottom rod is fixed on the first straight slider and adjacent to the first bending plate, wherein the second shaft extends along a second axis, and the second straight slide groove extends substantially perpendicular to the second axis, and wherein the second transmission member further includes a second bending plate and a second straight slider, the second bending plate extends along a radial direction of the second axis and is bent, the second straight slider extends outward from the second bending plate along the radial direction of the second axis and is slidably disposed in the second straight slide groove, and the second bottom rod is fixed on the second straight slider and adjacent to the second bending plate.

In the aforementioned foldable electronic device, the first transmission member further includes a first driving cam, the second transmission member further includes a second driving cam, the pushing member has a first driven cam and a second driven cam, the first driving cam is slidably sleeved on the first shaft along the first axis and connected to the first bending plate, and fits with the first driven cam, the second driving cam is slidably sleeved on the second shaft along the second axis and connected to the second bending plate, and fits with the second driven cam.

In the aforementioned foldable electronic device, the pivot module includes a fixed base, a first shaft hole and a second shaft hole, the fixed base has a first wing portion and a second wing portion, the first shaft hole is formed through the first wing portion along the first axis, and the first shaft inserts through the first shaft hole, the second shaft hole is formed through the second wing portion along the second axis, and the second shaft inserts through the second shaft hole.

In the aforementioned foldable electronic device, the first driven cam is sleeved on the first shaft, the second driven cam is sleeved on the second shaft, the first driving cam and the first driven cam are matched and engaged with each other, the second driving cam and the second driven cam are matched and engaged with each other, the elastic module further includes a first elastic member and a second elastic member respectively sleeved on the first shaft and the second shaft, two ends of the first elastic member respectively abut against the first wing portion and the first driven cam, two ends of the second elastic member respectively abut against the second wing portion and the second driven cam, when the first panel body and the second panel body are in the half-folded state between the unfolded state and the folded state, the first driving cam and the second driving cam abut against the first driven cam and the second driven cam, the first elastic member and the second elastic member are compressed, and when the first carrying member and the second carrying member are in the unfolded state or the folded state, the first elastic member and the second elastic member are released correspondingly.

In the aforementioned foldable electronic device, the first axis, the first inner virtual axis, the first outer virtual axis, the second axis, the second inner virtual axis and the second outer virtual axis are parallel to each other.

In the aforementioned foldable electronic device, the first elastic member and the second elastic member are respectively a compression spring.

In the aforementioned foldable electronic device, the synchronization module further includes a first helical protrusion, a second helical protrusion, a first helical groove and a second helical groove, the first helical protrusion is matched and accommodated in the first helical groove, and the second helical protrusion is matched and accommodated in the second helical groove.

The aforementioned foldable electronic device, the first helical groove is recessed in the first transmission member along a first helical direction, the second helical groove is recessed in the second transmission member along a second helical direction and corresponds to the first helical groove, the first helical protrusion and the second helical protrusion are respectively formed on two opposite surfaces of the synchronization slider body.

In the aforementioned foldable electronic device, the first helical direction is opposite to the second helical direction.

In the aforementioned foldable electronic device, the central base further includes a housing covering the body portion, when the first panel body and the second panel body are in the unfolded state, the first drop plate and the second drop plate contact a top side of the housing, and when the first panel body and the second panel body are in the folded state, the first drop plate and the second drop plate are away from the housing.

In the aforementioned foldable electronic device, the central base further includes a track groove formed through the track portion, the synchronization module further includes a limiting rib formed on the synchronization slider body, and the limiting rib is slidably accommodated in the track groove.

As can be understood from the above, the foldable electronic device of the present disclosure generates a first degree of freedom and a second degree of freedom respectively through a first connecting rod and a second connecting rod, it can match different deformation amounts and shapes of different flexible screens during bending, and can correspondingly provide accommodation spaces according to different free angles, allowing adaptation to the deformation of various flexible screens at any time.

### BRIEF DESCRIPTION OF THE DRAWINGS

FIG. 1 is a schematic view of a foldable electronic device of the present disclosure in an unfolded state.

FIG. 2 is a schematic exploded view of the foldable electronic device of the present disclosure in an unfolded state.

FIG. 3 is a schematic exploded view of the foldable electronic device of the present disclosure.

FIG. 4 is a schematic exploded view of some components of the foldable electronic device of the present disclosure.

FIG. 5 is a schematic exploded view of some components of the foldable electronic device of the present disclosure.

FIG. 6 is a schematic bottom view of a first drop plate and a second drop plate of the foldable electronic device of the present disclosure.

FIG. 7 is a schematic top view of a first transmission member, a second transmission member and a synchronization module of the foldable electronic device of the present disclosure.

FIG. 8 is a schematic top view of a first transmission member, a second transmission member and an elastic module of the foldable electronic device of the present disclosure in an unfolded state.

FIG. 9 is a schematic top view of a first transmission member, a second transmission member and an elastic module of the foldable electronic device of the present disclosure in a half-folded state.

FIG. 10 is a schematic top view of a first transmission member, a second transmission member and an elastic module of the foldable electronic device of the present disclosure in a folded state.

FIG. 11 is a schematic cross-sectional view of the foldable electronic device of the present disclosure in an unfolded state.

FIG. 12 is a schematic cross-sectional view of the foldable electronic device of the present disclosure in an unfolded state.

FIG. 13 is a schematic cross-sectional view of a foldable electronic device of the present disclosure in a half-folded state.

FIG. 14 is a schematic cross-sectional view of a foldable electronic device of the present disclosure in a folded state.

### DETAILED DESCRIPTION

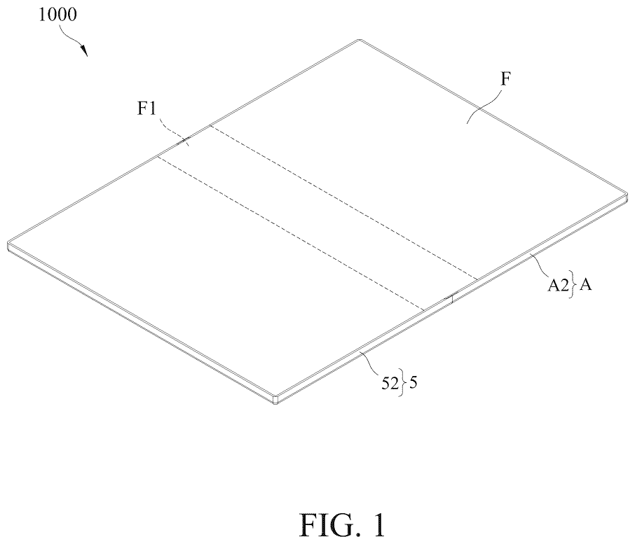

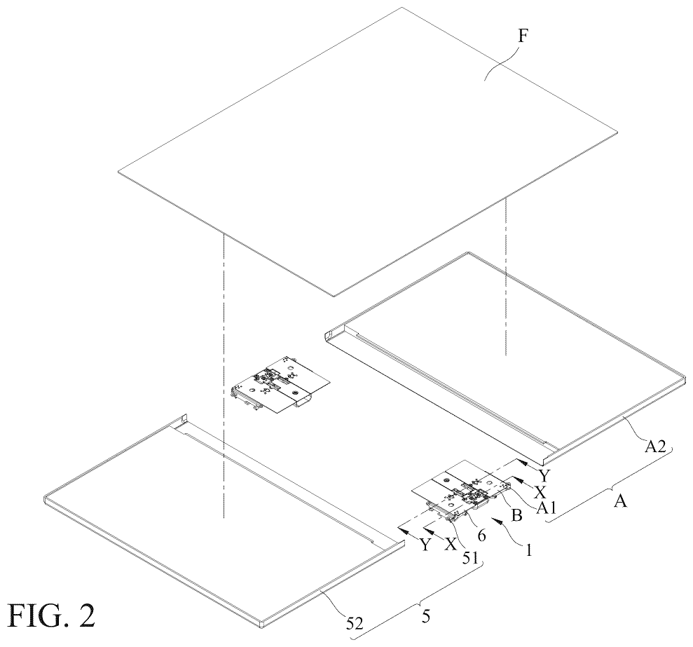

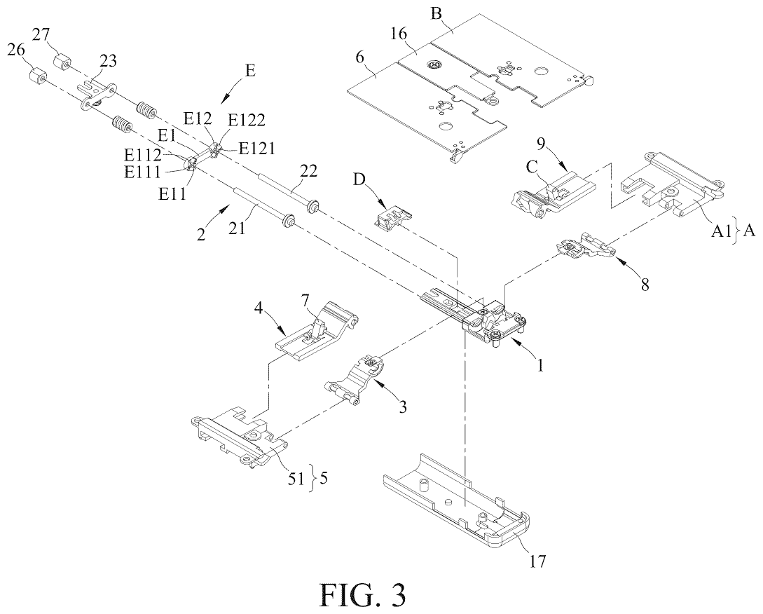

Referring to FIG. 1, FIG. 2 and FIG. 3, a foldable electronic device 1000 includes a central base 1, a pivot module 2, a first wing member 3, a first transmission member 4, a first panel body 5, a first drop plate 6, a first connecting rod 7, a second wing member 8, a second transmission member 9, a second panel body A, a second drop plate B, a second connecting rod C, a synchronization module D, an elastic module E, and a flexible screen F. The pivot module 2 is disposed on the central base 1, the first wing member 3 and the second wing member 8 are respectively pivotally connected to two sides of the central base 1. The first transmission member 4 and the second transmission member 9 are respectively connected to two sides of the pivot module 2, the synchronization module D and the elastic module E. The first panel body 5 is connected to the first wing member 3, the first drop plate 6 is connected to the first panel body 5, the first connecting rod 7 is connected to the first transmission member 4 and the first drop plate 6. The second panel body A is connected to the second wing member 8, the second drop plate B is connected to the second panel body A, the second connecting rod C is connected to the second transmission member 9 and the second drop plate B. The synchronization module D is disposed on the central base 1 and slidably disposed between the first transmission member 4 and the second transmission member 9, the elastic module E is disposed on the central base 1 and connected to the pivot module 2. The flexible screen F is disposed on the central base 1, the first panel body 5, the first drop plate 6, the second panel body A and the second drop plate B. The structure of each component and connection relationship between each other will be described in detail below Some figures are drawn with a first inner virtual axis V1, a second inner virtual axis V2, a first outer virtual axis V3, a second outer virtual axis V4, a first axis X1, a second axis X2 that are parallel to each other without overlapping. It should be noted that some components of a foldable electronic device 1000 of the present disclosure may be arranged in one set or a plurality of sets, all of which can achieve the operational effect of the present disclosure. The following is a simplified description, and only one set is illustrated for example.

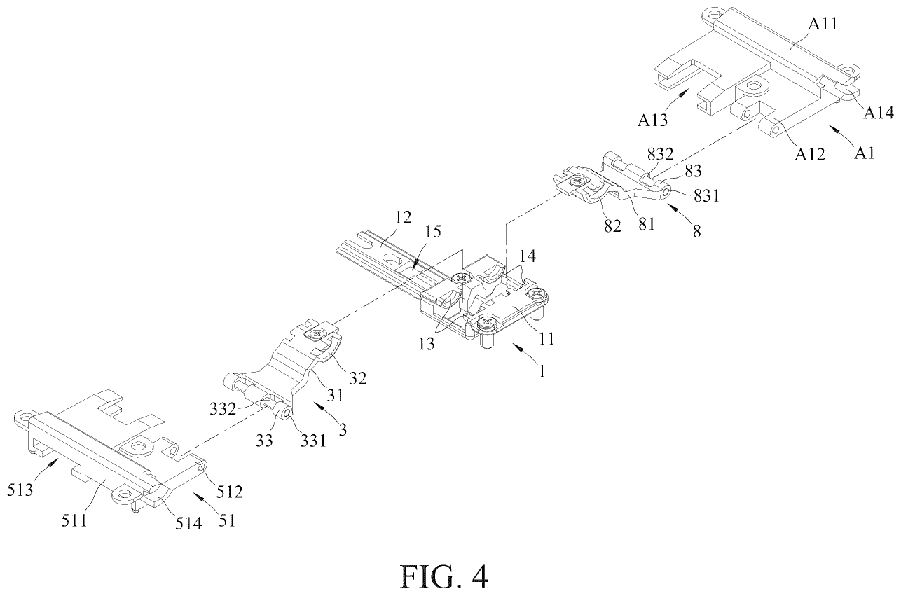

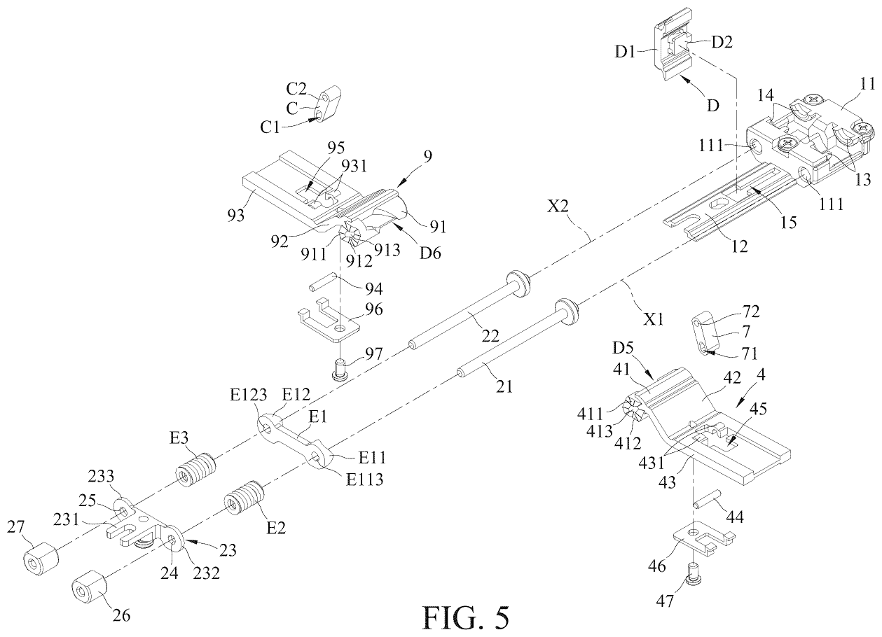

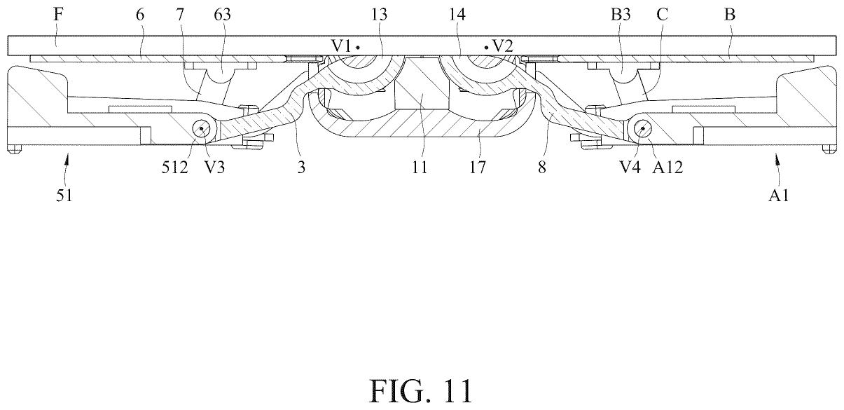

Please referring to FIG. 4 and FIG. 5, the central base 1 includes a body portion 11, a track portion 12, two first inner arc-shaped sliders 13, two second inner arc-shaped sliders 14, a track groove 15, a top plate 16 and a housing 17. The body portion 11 has two concave holes 111 spaced apart, the concave holes 111 are respectively formed along the first axis X1 and the second axis X2. The track portion 12 is generally in the shape of a long plate and extends outward from the body portion 11. The first inner arc-shaped sliders 13 are generally in the form of semi-arc bodies, protruding from the body portion 11, spaced apart from each other, opposite to each other, and adjacent to one side of the body portion 11 (i.e., adjacent to the first panel body 5). The first inner arc-shaped sliders 13 have a common axis defined as the first inner virtual axis V1 (see FIG. 11). The second inner arc-shaped sliders 14 are generally in the form of semi-arc bodies, protruding from the body portion 11, spaced apart from each other, opposite to each other, and spaced apart from the first inner arc-shaped sliders 13, and adjacent to another side of the body portion 11 (i.e., adjacent to the second panel body A). The second inner arc-shaped sliders 14 have a common axis defined as the second inner virtual axis V2 (see FIG. 11). The track groove is formed through the track portion 12 and extends along a direction parallel to the first axis X1. The top plate 16 is fixedly connected to the body portion 11 and track portion 12 and is located above the pivot module 2, the synchronization module D and the elastic module E. The housing 17 covers the bottom side and the front side of the body portion 11. The pivot module 2 includes a first shaft 21, a second shaft 22, a fixed base 23, a first shaft hole 24, a second shaft hole 25, a first nut 26 and a second nut 27. The first shaft 21 is pivotally connected to one of the concave holes 111 along the first axis X1. The second shaft 22 is pivotally connected to the other one of the concave holes 111 along the second axis X2. The fixed base 23 has a base body 231, a first wing portion 232 and a second wing portion 233. The base body 231 is disposed on the track portion 12 and exposes the track groove 15, and spaced apart from the body portion 11. The first wing portion 232 and the second wing portion 233 respectively extend from opposite sides of the base body 231. The first shaft hole 24 penetrates the first wing portion 232 along the first axis X1 and is used for the first shaft 21 to insert through and be pivotally connected. The second shaft hole 25 penetrates the second wing portion 233 along the second axis X2 and is used for the second shaft 22 to insert through and be pivotally connected. The first nut 26 is screwed onto one end of the first shaft 21 away from the body portion 11, the second nut 27 is screwed onto one end of the second shaft 22 away from the body portion 11.

The first wing member 3 includes a first wing body 31, two first inner arc-shaped slideways 32 and a first pivot portion 33. The first wing body 31 is generally in the shape of a bent body. The first inner arc-shaped slideways 32 are spaced apart and recessed on one side of the first wing body 31 adjacent to the body portion 11, and are respectively used for the first inner arc-shaped sliders 13 to slide correspondingly, so that the first wing member 3 can pivot relative to the body portion 11 with the first inner virtual axis V1 as the center. The first pivot portion 33 is disposed on one side of the first wing body 31 away from the body portion 11, and has a first pivot portion hole 331 extending along the first outer virtual axis V3 and a first pivot portion rod 332 penetrating through the first pivot portion hole 331.

The first transmission member 4 includes a first driving cam 41, a first bending plate 42, a first straight slider 43, a first bottom rod 44, a first through groove 45, a first cover 46 and a first screw 47. The first driving cam 41 is an end cam and has three first driving convex portions 411, three first driving concave portions 412 and a first driving penetration hole 413. The first driving convex portions 411 and the first driving concave portions 412 extend outward along the first axis X1 and are interlaced with each other in an annular configuration. The first driving penetration hole 413 is formed through the first axis X1 and used for the first shaft 21 to insert through. The first bending plate 42 extends outward from the first driving cam 41 along the radial direction of the first axis X1. The first straight slider 43 extends outward from the first bending plate 42 along the radial direction of the first axis X1, and has two first receiving portions 431 spaced apart. The first bottom rod 44 is disposed in the first receiving portions 431 and adjacent to the first bending plate 42. The first through groove 45 is formed through the first straight slider 43 and located between the first receiving portions 431, allowing the first bottom rod 44 to be partially exposed. The first cover 46 is generally in the form of a U-shaped plate. The first screw 47 inserts through the first cover 46 and is locked at the bottom of the first straight slider 43, so that the first cover 46 is fixed at the bottom of the first straight slider 43 and corresponds to the first receiving portions 431 to prevent the first bottom rod 44 from being detached from the first receiving portions 431.

The first panel body 5 includes a first carrying member 51 and a first panel housing 52. The first carrying member 51 has a first carrying body 511, a first pivoting part 512, a first straight slide groove 513 and a first outer arc-shaped slideway 514. The first pivoting part 512 extends outward from the first carrying body 511 and is pivotally connected to the first pivot portion rod 332, thereby jointly defining the first outer virtual axis V3 (see FIG. 11), so that the first carrying member 51 can rotate relative to the first wing member 3 about the first outer virtual axis V3. The first straight slide groove 513 is defined and surrounded by the first carrying body 511, generally perpendicular to the first axis X1, used for the first straight slider 43 to slide linearly, whereby the first carrying member 51 can move linearly relative to the first transmission member 4. The first outer arc-shaped slideway 514 is formed on the first carrying body 511 and spaced apart from the first pivoting part 512. The first panel housing 52, generally in the shape of quadrilateral, is fixed to the first carrying member 51 and coplanar with the top plate 16. In addition, the first panel body 5 further includes electronic components, but they are relatively irrelevant to the folding operation and will not be described again.

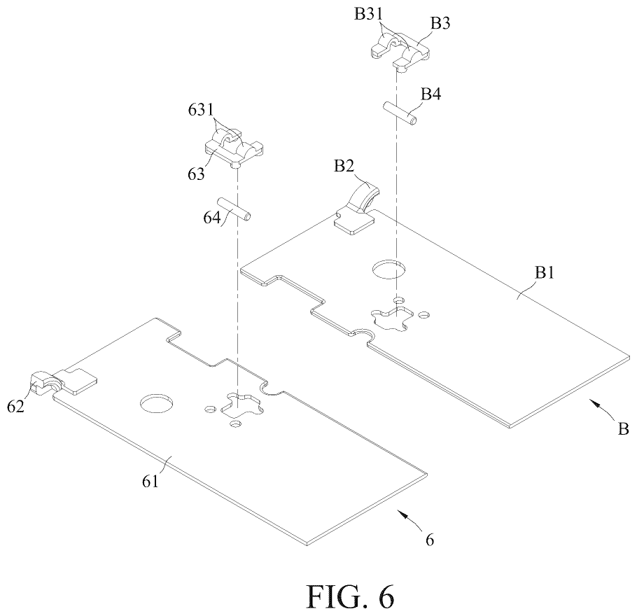

Please referring to FIG. 6, the first drop plate 6 includes a first plate body 61, a first outer arc-shaped slider 62, a first fixing member 63 and a first top rod 64. The first plate body 61 is generally rectangular. The first outer arc-shaped slider 62 is disposed at one corner of the first plate body 61 and slidably disposed on the first outer arc-shaped slideway 514, so that the first drop plate 6 can be pivotally carried on the first carrying member 51. The first fixing member 63, generally in the form of a U-shaped plate, is fixed on the bottom surface of the first plate body 61 and has two first accommodation portions 631 spaced apart from each other. The first top rod 64 is disposed in the first accommodation portion 631, so that the first fixing member 63 partially exposes the first top rod 64.

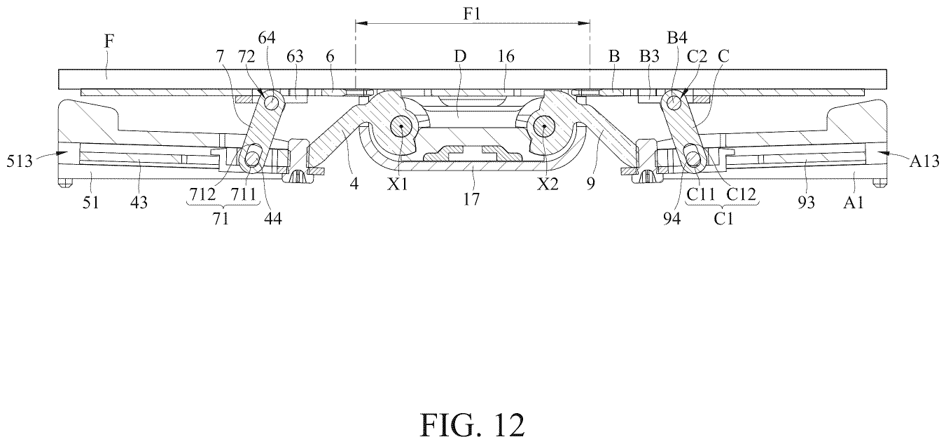

Please referring FIG. 12, the first connecting rod 7 includes a first elongated slide groove 71 and a first through hole 72 spaced apart. The first elongated slide groove 71 has a first head end 711 and a first tail end 712 opposite to the first head end 711, and the cross-section of the first elongated slide groove 71 is larger than the cross-section of the first bottom rod 44. The first bottom rod 44 is slidably disposed in the first elongated slide groove 71, one end of the first connecting rod 7 is located in the first through groove 45 and can pivot and move relative to the first straight slider 43. The first top rod 64 inserts through the first through hole 72, whereby the other end of the first connecting rod 7 is pivotally connected to the first drop plate 6. By the pivoting angle of the first connecting rod 7 relative to the first drop plate 6, the pivoting angle of the first connecting rod 7 relative to the first transmission member 4 and the linear movement space of the first elongated slide groove 71, the first connecting rod 7 can generate a first degree of freedom. In other words, the first degree of freedom is the various possible combinations of the various pivoting angles of the first connecting rod 7 relative to the first drop plate 6 and the first transmission member 4 and different linear movement positions of the first elongated slide groove 71.

The second wing member 8 includes a second wing body 81, two second inner arc-shaped slideways 82 and a second pivot portion 83. The second wing body 81 is generally in the shape of a bent body. The second inner arc-shaped slideways 82 are spaced apart and recessed on one side of the second wing body 81 adjacent to the body portion 11, and are respectively used for the second inner arc-shaped sliders 14 to slide correspondingly, so that the second wing member 8 can pivot relative to the body portion 11 with the second inner virtual axis V2 as the center. The second pivot portion 83 is disposed on one side of the second wing body 81 away from the body portion 11, and has a second pivot portion hole 831 extending along the second outer virtual axis V4 and a second pivot portion rod 832 penetrating through the second pivot portion hole 831.

The second transmission member 9 includes a second driving cam 91, a second bending plate 92, a second straight slider 93, a second bottom rod 94, a second through groove 95, a second cover 96 and a second screw 97. The second driving cam 91 is an end cam and has three second driving convex portions 911, three second driving concave portions 912 and a second driving penetration hole 913. The second driving convex portions 911 and the second driving concave portions 912 extend outward along the second axis X2 and are interlaced with each other in an annular configuration. The second driving penetration hole 913 is formed through the second axis X2 and used for the second shaft 22 to insert through. The second bending plate 92 extends outward from the second driving cam 91 along the radial direction of the second axis X2. The second straight slider 93 extends outward from the second bending plate 92 along the radial direction of the second axis X2, and has two second receiving portions 931 spaced apart. The second bottom rod 94 is disposed in the second receiving portions 931 and adjacent to the second bending plate 92. The second through groove 95 is formed through the second straight slider 93 and located between the second receiving portions 931, allowing the second bottom rod 94 to be partially partly exposed. The second cover 96 is generally in the form of a U-shaped plate. The second screw 97 inserts through the second cover 96 and is locked at the bottom of the second straight slider 93, so that the second cover 96 is fixed at the bottom of the second straight slider 93 and corresponds to the second receiving portions 931 to prevent the second bottom rod 94 from being detached from the second receiving portions 931. The second panel body A includes a second carrying member A1 and a second

panel housing A2. The second carrying member A1 has a second carrying body A11, a second pivoting part A12, a second straight slide groove A13 and a second outer arc-shaped slideway A14. The second pivoting part A12 extends outward from the second carrying body A11 and is pivotally connected to the second pivot portion rod 832, thereby jointly defining the second outer virtual axis V4 (see FIG. 11), so that the second carrying member A1 can rotate relative to the second wing member 8 about the second outer virtual axis V4. The second straight slide groove A13 is defined and surrounded by the second carrying body A11, generally perpendicular to the second axis X2, used for the second straight slider 93 to slide linearly, whereby the second carrying member A1 can move linearly relative to the second transmission member 9. The second outer arc-shaped slideway A14 is formed on the second carrying body A11 and spaced apart from the second pivoting part A12. The second panel housing A2, generally in the shape of quadrilateral, is fixed to the second carrying member A1 and coplanar with the top plate 16 and the first carrying member 51. In addition, the second panel body A further includes electronic components, which will not be described again.

The second drop plate B includes a second plate body B1, a second outer arc-shaped slider B2, a second fixing member B3 and a second top rod B4. The second plate body B1 is generally rectangular The second outer arc-shaped slider B2 is disposed at one corner of the second plate body B1 and slidably disposed on the second outer arc-shaped slideway A14, so that the second drop plate B can be pivotally carried on the second carrying member A1. The second fixing member B3, generally in the form of a U-shaped plate, is fixed on the bottom surface of the second plate B1 and has two second accommodation portions B31 spaced apart from each other. The second top rod B4 is disposed in the second accommodation portion B31, so that the second fixing member B3 partially exposes the second top rod B4.

The second connecting rod C includes a second elongated slide groove C1 and a second through hole C2 spaced apart. The second elongated slide groove C1 has a second head end C11 and a second tail end C12 opposite to the second head end C11, and the cross-section of the second elongated slide groove C1 is larger than the cross-section of the second bottom rod 94. The second bottom rod 94 is slidably disposed in the second elongated slide groove C1, one end of the second connecting rod C is located in the second through groove 95 and can pivot and move relative to the second straight slider 93. The second top rod B4 inserts through the second through hole C2, whereby the other end of the second connecting rod C is pivotally connected to the second drop plate B. By the pivoting angle of the second connecting rod C relative to the second drop plate B, the pivoting angle of the second connecting rod C relative to the second transmission member 9 and the linear movement space of the second elongated slide groove C1, the second connecting rod C can generate a second degree of freedom. In other words, the second degree of freedom is the various possible combinations of the various pivoting angles of the second connecting rod C relative to the second drop plate B and the second transmission member 9 and different linear movement positions of the second elongated slide groove C1.

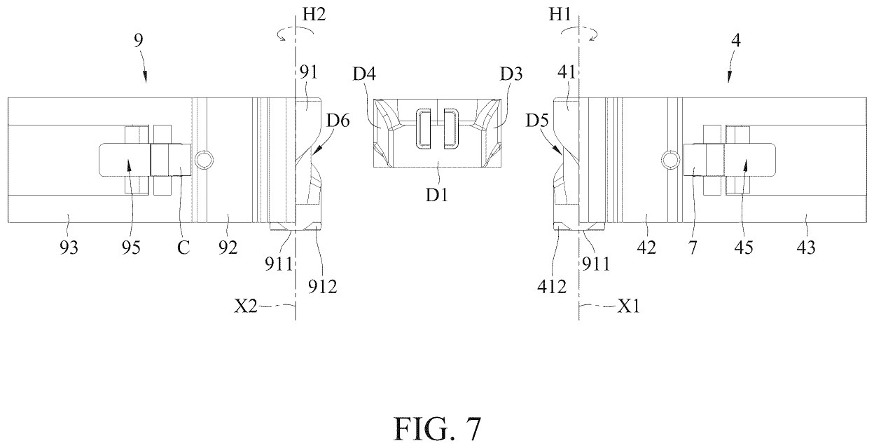

Please referring FIG. 7, the synchronization module D includes a synchronization slider body D1, a limiting rib D2, a first helical protrusion D3, a second helical protrusion D4, a first helical groove D5 and a second helical groove D6. The synchronization slider body D1 is slidably disposed between the first transmission member 4 and the second transmission member 9 and on the track portion 12, and connected to the first transmission member 4 and the second transmission member 9. The limiting rib D2 extends outward from the bottom surface of the synchronization slider body D1 and is slidably accommodated in the track groove 15, so that the synchronization slider body D1 can move along the track groove 15. The first helical protrusion D3 is formed on one of the two opposite side surfaces of the synchronization slider body D1 along the first helical direction H1. The second helical protrusion D4 is formed on the other one of the two opposite side surfaces of the synchronization slider body D1 along the second helical direction H2. The first helical groove D5 is recessed and formed in the first driving cam 41 along the first helical direction H1 and is adapted to match and accommodate the first helical protrusion D3. The second helical groove D6 is recessed and formed in the second driving cam 91 along the second helical direction H2 and is adapted to match and accommodate the second helical protrusion D4. In one embodiment, the first helical direction H1 is opposite to the second helical direction H2. In other embodiments, the first helical groove D5 and the second helical groove D6 can also be respectively recessed and formed on the two opposite side surfaces of the synchronization slider body D1, and the first helical protrusion D3 and the second helical protrusion D4 can also be respectively formed on the first driving cam 41 and the second driving cam 91, the present disclosure is not limited thereto.

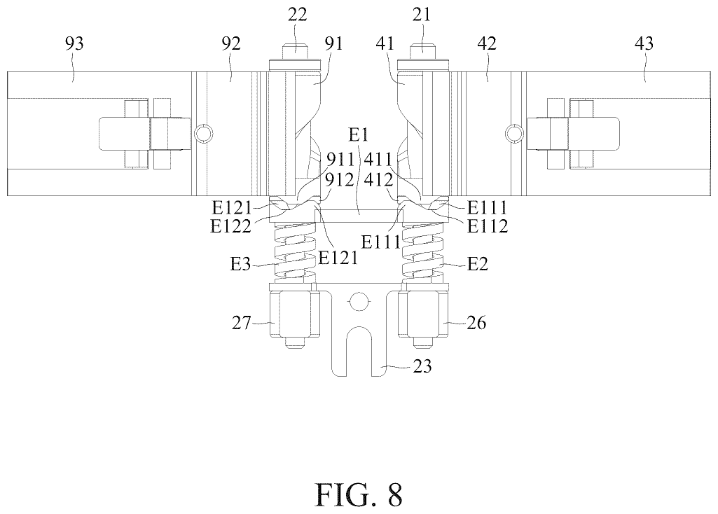

The elastic module E includes a pushing member E1, a first elastic member E2 and a second elastic member E3 The pushing member E1 is slidably sleeved on the first shaft 21 and the second shaft 22 at the same time, and has a first driven cam E11 and a second driven cam E12 spaced apart. The first driven cam E11 is an end cam, and matched and movably engaged with the first driving cam 41 (see FIG. 8 to FIG. 10). The first driven cam E11 has three first driven convex portions E111, three first driven concave portions E112 and a first driven penetration hole E113. The first driven convex portions E111 and the first driven concave portions E112 extend outward along the first axis X1 and are interlaced with each other in an annular configuration. The first driven penetration hole E113 is formed through the first axis X1 and is used for the first shaft 21 to insert through. The first driven penetration hole E113 has a circular cross-section area larger than a cross-section area of the first shaft 21, so that the first driven cam E11 can slide on the first shaft 21 along the first axis X1 but does not move synchronously. The second driven cam E12 is an end cam, and matched and movably engaged with the second driving cam 91 (see FIG. 8 to FIG. 10), and has three second driven convex portions E121, three second driven concave portions E122 and a second driven penetration hole E123. The second driven convex portions E121 and the second driven concave portions E122 extend outward along the second axis X2 and are interlaced with each other in an annular configuration. The second driven penetration hole E123 is formed through the second axis X2 and is used for the second shaft 22 to insert through. The second driven penetration hole E123 has a circular cross-section area larger than a cross-section of the second shaft 22, so that the second driven cam E12 can slide on the second shaft 22 along the second axis X2 but does not move synchronously. The first elastic member E2 is sleeved on the first shaft 21, and its two ends respectively abut against the first wing portion 232 and the first driven cam E11 The second elastic member E3 is sleeved on the second shaft 22, and its two ends respectively abut against the second wing portion 233 and the second driven cam E12. In one embodiment, the first elastic member E2 and the second elastic member E3 are respectively a compression spring.

The flexible screen F is disposed on the first panel body 5, the first drop plate 6, the second panel body A, the second drop plate B and the central base 1, and includes a bendable area F1 The bendable area F1 generally corresponds to the top plate 16, the first wing member 3, the first drop plate 6, the second wing member 8 and the second drop plate B.

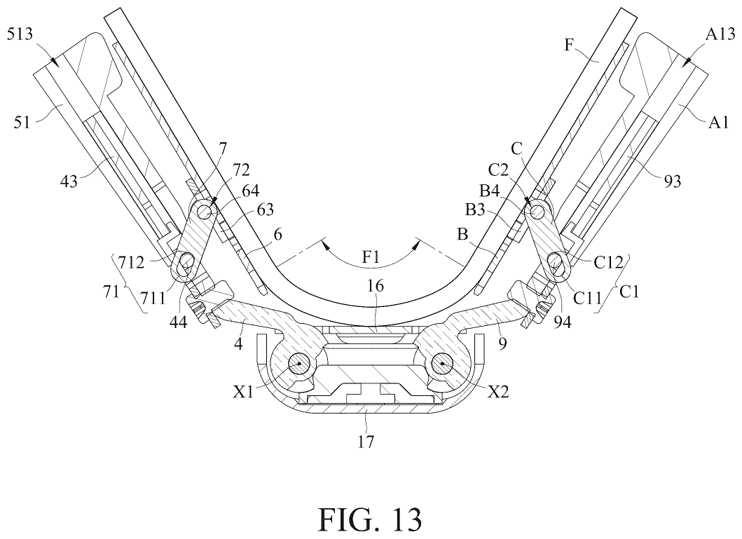

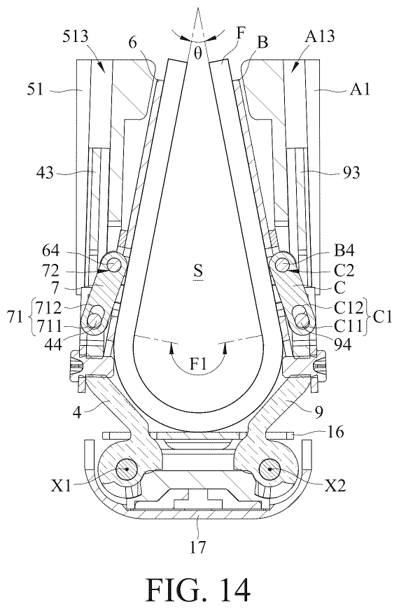

The following describes the operation of the foldable electronic device 1000 of the present disclosure. The first panel body 5 and the second panel body A are able to change between an unfolded state (as shown in FIG. 1, FIG. 2, FIG. 11 and FIG. 12), a half-folded state (see FIG. 13), and a folded state (see FIG. 14). When the first panel body and the second panel body A are in the unfolded state, the flexible screen F is flattened, the top plate 16, the first drop plate 6 and the second drop plate B are coplanar and jointly support the bendable area F1, and the first drop plate 6 and the second drop plate B contact to the top side of the housing 17. As shown in FIG. 8 (only the pivot module 2, the first transmission member 4, the second transmission member 9 and the elastic module E are shown), at this time, the first driving cam 41 and the first driven cam E11 are matched and engaged with each other. That is, each of the first driving convex portions 411 respectively extends into each of the first driven concave portions E112, and one side surface of each of the first driving convex portions 411 partially contacts one side surface of each of the first driven convex portions E111 and generates friction. The sum of the lengths of the first driving cam 41 and the first driven cam E11 on the first axis X1 is minimized. The second driving cam 91 and the second driven cam E12 are matched and engaged with each other. That is, each of the second driving convex portions 911 respectively extends into each of the second driven concave portions E122, and one side surface of each of the second driving convex portions 911 partially contacts one side surface of each of the second driven convex portions E121 and generates friction. The sum of the lengths of the second driving cam 91 and the second driven cam E12 on the second axis X2 is minimized, and the first elastic member E2 and the second elastic member E3 are correspondingly released (i.e., the amount of compression is minimum). Meanwhile, as shown in FIG. 12, the first bottom rod 44 abuts against the first head end 711 of the first elongated slide groove 71, and the second bottom rod 94 abuts against the second head end C11 of the second elongated slide groove C1.

When the first panel body 5 and the second panel body A change from the unfolded state to the folded state, the first wing member 3 and the second wing member 8 pivot relative to the body portion 11 with the first inner virtual axis V1 and the second inner virtual axis V2 respectively as the center and gradually move closer to each other (i.e., from a state where the first drop plate 6, the second drop plate B and the top plate 16 are coplanar, gradually becoming to a state where the first drop plate 6 and the second drop plate B are obliquely intersected with the top plate 16 respectively). At this time, the first carrying member 51 and the second carrying member A1 pivot and move relative to the first wing member 3 and the second wing member 8 respectively with the first outer virtual axis V3 and the second outer virtual axis V4 as the center, and the first straight slider 43 and the second straight slider 93 linearly slide in the first straight slide groove 513 and the second straight slide groove A13 respectively (i.e., gradually slide away from the first straight slide groove 513 and the second straight slide groove A13). At the same time, the first driving cam 41 and the first bending plate 42 pivot about the first axis X1 as the center, and the second driving cam 91 and the second bending plate 92 pivot about the second axis X2 as the center. Since the first helical direction H1 and the second helical direction H2 of the first helical groove D5 and the second helical groove D6 on the opposite sides of the synchronization slider body D1 are opposite to each other, the first helical protrusion D3 and the second helical protrusion D4 slide along the first helical groove D5 and the second helical groove D6 respectively, driving the first transmission member 4 and the second transmission member 9 to rotate reversely and synchronously. At the same time, one end of the first connecting rod 7 pivots relative to the first drop plate 6 with the first top rod 64 as the axle center, the other end of the first connecting rod 7 pivots relative to the first straight slider 43 with the first bottom rod 44 as the axle center, and the first bottom rod 44 can slide in the first elongated slide groove 71, while one end of the second connecting rod C pivots relative to the second drop plate B with the second top rod B4 as the axle center, the other end of the second connecting rod C pivots relative to the second straight slider 93 with the second bottom rod 94 as the axle center, and the second bottom rod 94 can slide in the second elongated slide groove C1.

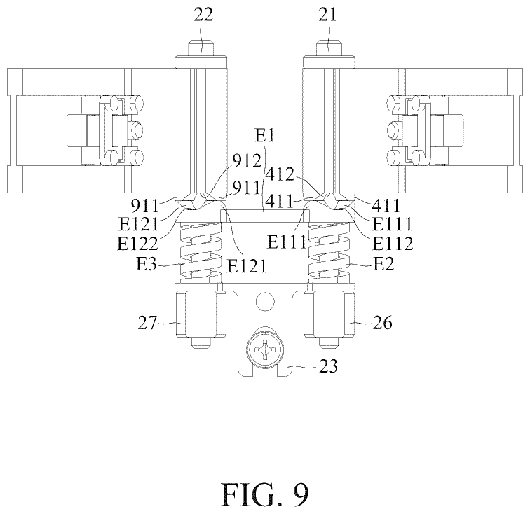

When the first panel body 5 and the second panel body A change from the unfolded state to the folded state, the first driving cam 41 and the second driving cam 91 gradually push away the first driven cam E11 and the second driven cam E12 respectively, and gradually compress the first elastic member E2 and the second elastic member E3 (i.e., the compression amount gradually becomes larger). When the first panel body 5 and the second panel body A change to the half-folded state between the unfolded state and the folded state, as show in FIG. 9 (the pivot module 2, the first transmission member 4, the second transmission member 9 and elastic module E are shown), the first driving cam 41 and the second driving cam 91 are respectively in a mutually abutting state with the first driven cam E11 and the second driven cam E12. That is, each of the first driving convex portions 411 respectively corresponds to and abuts against each of the first driven convex portions E111, each of the first driving concave portions 412 respectively corresponds to each of the first driven concave portions E112, each of the second driving convex portions 911 respectively corresponds to and abuts against each of the second driven convex portions E121, each of the second driving concave portions 912 respectively corresponds to the second driven concave portions E122. The pushing member E1 moves to the fixed base 23 along the first shaft 21 and the second shaft 22, thereby compressing the first elastic member E2 and the second elastic member E3 (i.e., the compression amount is maximum). At this time, the sum of the lengths of the first driving cam 41 and the first driven cam E11 on the first axis X1 is maximized, and the sum of the lengths of the second driving cam 91 and the second driven cam E12 on the second axis X2 is maximized. Meanwhile, as shown in FIG. 13, the first bottom rod 44 gradually moves away from the first head end 711 of the first elongated slide groove 71 and finally abuts against the first tail end 712, and the second bottom rod 94 gradually moves away from the second head end C11 of the second elongated slide groove C1 and finally abuts against the second tail end C12.

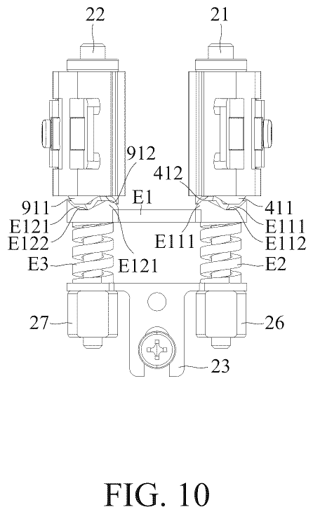

When the first panel body 5 and the second panel body A further change toward the folded state, as shown in FIG. 10 (only the pivot module 2, the first transmission member 4, the second transmission member 9 and elastic module E are shown), the first driving cam 41 and the first driven cam E11 are gradually matched and engaged with each other. That is, each of the first driving convex portions 411 respectively extends into each of the first driven concave portions E112 again, and the side surface of each of the first driving convex portions 411 partially contacts the side surface of each of the first driven convex portions E111 (i.e., in contact with each other on the other side) and generates friction. The second driving cam 91 and the second driven cam E12 are gradually matched and engaged with each other. That is, each of the second driving convex portions 911 respectively extends into each of the second driven concave portions E122 again, and the side surface of each of the second driving convex portions 911 partially contacts the side surface of each of the second driven convex portions E121 (i.e., in contact with each other on the other side) and generates friction, causing the first elastic member E2 and the second elastic member E3 to be gradually released (i.e., the amount of compression gradually becomes smaller). At the same time, the first bottom rod 44 gradually moves away from the first tail end 712 of the first elongated slide groove 71, and the second bottom rod 94 gradually moves away from the second tail end C12 of the second elongated slide groove C1.

When the first panel body 5 and the second panel body A change to the folded state, the sum of the lengths of the first driving cam 41 and the first driven cam E11 on the first axis X1 is minimized, and the sum of the lengths of the second driving cam 91 and the second driven cam E12 on the second axis X2 is minimized, the first elastic member E2 and the second elastic member E3 are released, the first drop plate 6 and the second drop plate B are away from the top side of the housing 17. As shown in FIG. 14, the first bottom rod 44 is between the first head end 711 and the first tail end 712, the second bottom rod 94 is between the second head end C11 and the second tail end C12 (in other embodiments, the first bottom rod 44 can also directly abut against the first head end 711, the second bottom rod 94 can also directly abut against the second head end C11). At this time, the first drop plate 6 and the second drop plate B are respectively obliquely intersected with the body portion 11, and the first degree of freedom and the second degree of freedom cooperate to make ends of the first drop plate 6 and the second drop plate B away from the central base 1 approach each other and from a free angle θ. The bendable area F1 of the flexible screen F is bent, the first drop plate 6, the second drop plate B and the central base 1 jointly define an accommodation space S to accommodate the bendable area F1, and the bendable area F1, the first drop plate 6 and the second drop plate B are generally in the shape of a water drop.

Since the first bottom rod 44 can slide in the first elongated slide groove 71, and the second bottom rod 94 can slide in the second elongated slide groove C1, the first degree of freedom and the second degree of freedom can change the size of the free angle θ corresponding to the bending degree of the bendable area F1. For example, when the accommodation space S required for the bendable area F1 of the flexible screen F is small, the free angle θ is correspondingly small. At this time, the first bottom rod 44 is between the first head end 711 and the first tail end 712, and the second bottom rod 94 is between the second head end C11 and the second tail end C12. When the accommodation space S required for the bendable area F1 of the flexible screen F is large, the free angle θ is correspondingly large. At this time, the first bottom rod 44 abuts against the first head end 711, and the second bottom rod 94 abuts against the second head end C11.

In view of the above, the foldable electronic device of the present disclosure generates a first degree of freedom and a second degree of freedom respectively through a first connecting rod and a second connecting rod, it can match different deformation amounts and shapes of different flexible screens during bending, and can correspondingly provide accommodation spaces according to different free angles, allowing adaptation to the deformation of various different flexible screens at any time.

What is claimed is:

1. A foldable electronic device, comprising:
a central base including a body portion, a track portion, at least one first inner arc-shaped slider and at least one second inner arc-shaped slider, wherein the track portion extends outward from the body portion, and the first inner arc-shaped slider and the second inner arc-shaped slider are respectively formed on the body portion and spaced apart from each other;
a pivot module disposed on the central base and including a first shaft and a second shaft respectively pivotally connected to the body portion;
a first wing member including at least one first inner arc-shaped slideway and a first pivot portion, wherein the first inner arc-shaped slider is slidably disposed on the first inner arc-shaped slideway, whereby the first wing member is able to pivot relative to the body portion with a first inner virtual axis as a center;
a first transmission member sleeved on the first shaft and including a first bottom rod;
a first panel body including a first carrying member, the first carrying member having a first pivoting part and a first straight slide groove, wherein the first pivoting part is pivotally connected to the first pivot portion and jointly define a first outer virtual axis, whereby the first carrying member is able to rotate relative to the first wing member about the first outer virtual axis, and the first transmission member is slidably disposed in the first straight slide groove, whereby the first carrying member is able to slide linearly relative to the first transmission member;
a first drop plate pivotally carried on the first carrying member;
a first connecting rod pivotally connected to the first drop plate and including a first elongated slide groove, wherein the first bottom rod is slidably disposed in the first elongated slide groove, so that a first degree of freedom is formed thereof;
a second wing member including at least one second inner arc-shaped slideway and a second pivot portion, wherein the second inner arc-shaped slider is slidably disposed on the second inner arc-shaped slideway, whereby the second wing member is able to pivot relative to the body portion with a second inner virtual axis as a center;
a second transmission member sleeved on the second shaft and including a second bottom rod;
a second panel body including a second carrying member, the second carrying member having a second pivoting part and a second straight slide groove, wherein the second pivoting part is pivotally connected to the second pivot portion and jointly define a second outer virtual axis, whereby the second carrying member is able to rotate relative to the second wing member about the second outer virtual axis, and the second transmission member is slidably disposed in the second straight slide groove, whereby the second carrying member is able to slide linearly relative to the second transmission member;
a second drop plate pivotally carried on the second carrying member;
a second connecting rod pivotally connected to the second drop plate and including a second elongated slide groove, wherein the second bottom rod is slidably disposed in the second elongated slide groove, so that a second degree of freedom is formed thereof;
a synchronization module including a synchronization slider body slidably disposed between the first transmission member and the second transmission member, wherein the first transmission member and the second transmission member are respectively connected to the synchronization slider body, and wherein the synchronization slider body is able to drive the first transmission member and the second transmission member to rotate synchronously and reversely, respectively, when the synchronization slider body slides;
an elastic module including a pushing member, wherein the pushing member is slidably sleeved on the first shaft and the second shaft and movably engaged with the first transmission member and the second transmission member; and
a flexible screen disposed on the first panel body, the second panel body, the first drop plate, the second drop plate and the central base, and including a bendable area;
wherein the first panel body and the second panel body are able to change between an unfolded state and a folded state, wherein when the first panel body and the second panel body are in the unfolded state, the flexible screen is flattened, and the first drop plate, the second drop plate and the central base jointly support the bendable area, wherein when the first panel body and the second panel body are in the folded state, the bendable area of the flexible screen is bent, and the first drop plate, the second drop plate and the central base jointly define an accommodation space to accommodate the bendable area, and wherein a free angle between the first drop plate and the second drop plate is formed by cooperating of the first degree of freedom and the second degree of freedom, and the free angle is able to vary according to a bending degree of the bendable area.

2. The foldable electronic device of claim 1, wherein the first elongated slide groove has a first head end and a first tail end opposite each other, the second elongated slide groove has a second head end and a second tail end opposite each other, wherein when the first panel body and the second panel body are in the unfolded state, the first bottom rod abuts against the first head end and the second bottom rod abuts against the second head end, wherein when the first panel body and the second panel body are in a half-folded state between the unfolded state and the folded state, the first bottom rod abuts against the first tail end and the second bottom rod abuts against the second tail end, and wherein when the first panel body and the second panel body are in the folded state, the first bottom rod is located between the first head end and the first tail end, allowing the first degree of freedom to be formed, and the second bottom rod is located between the second head end and the second tail end, allowing the second degree of freedom to be formed.

3. The foldable electronic device of claim 2, wherein the first drop plate includes a first outer arc-shaped slider and a first top rod, the first carrying member further has a first outer arc-shaped slideway, and the first outer arc-shaped slider is slidably disposed on the first outer arc-shaped slideway, wherein the first connecting rod further includes a first through hole spaced apart from the first elongated slide groove, and the first top rod inserts through the first through hole, wherein the second drop plate includes a second outer arc-shaped slider and a second top rod, the second carrying member further has a second outer arc-shaped slideway, and the second outer arc-shaped slider is slidably disposed on the second outer arc-shaped slideway, and wherein the second connecting rod further includes a second through hole spaced apart from the second elongated slide groove, and the second top rod inserts through the second through hole.

4. The foldable electronic device of claim 3, wherein the first shaft extends along a first axis, and the first straight slide groove extends substantially perpendicular to the first axis, wherein the first transmission member further includes a first bending plate and a first straight slider, the first bending plate extends along a radial direction of the first axis and is bent, the first straight slider extends outward from the first bending plate along the radial direction of the first axis and is slidably disposed in the first straight slide groove, and the first bottom rod is fixed on the first straight slider and adjacent to the first bending plate, wherein the second shaft extends along a second axis, and the second straight slide groove extends substantially perpendicular to the second axis, and wherein the second transmission member further includes a second bending plate and a second straight slider, the second bending plate extends along a radial direction of the second axis and is bent, the second straight slider extends outward from the second bending plate along the radial direction of the second axis and is slidably disposed in the second straight slide groove, and the second bottom rod is fixed on the second straight slider and adjacent to the second bending plate.

5. The foldable electronic device of claim 4, wherein the first transmission member further includes a first driving cam, the second transmission member further includes a second driving cam, the pushing member has a first driven cam and a second driven cam, wherein the first driving cam is slidably sleeved on the first shaft along the first axis and connected to the first bending plate, and fits with the first driven cam, and wherein the second driving cam is slidably sleeved on the second shaft along the second axis and connected to the second bending plate, and fits with the second driven cam.

6. The foldable electronic device of claim 5, wherein the pivot module includes a fixed base, a first shaft hole and a second shaft hole, the fixed base has a first wing portion and a second wing portion, the first shaft hole is formed through the first wing portion along the first axis, and the first shaft inserts through the first shaft hole, the second shaft hole is formed through the second wing portion along the second axis, and the second shaft inserts through the second shaft hole.

7. The foldable electronic device of claim 6, wherein the first driven cam is sleeved on the first shaft, the second driven cam is sleeved on the second shaft, the first driving cam and the first driven cam are matched and engaged with each other, the second driving cam and the second driven cam are matched and engaged with each other, wherein the elastic module further includes a first elastic member and a second elastic member respectively sleeved on the first shaft and the second shaft, two ends of the first elastic member respectively abut against the first wing portion and the first driven cam, two ends of the second elastic member respectively abut against the second wing portion and the second driven cam, wherein when the first panel body and the second panel body are in the half-folded state between the unfolded state and the folded state, the first driving cam and the second driving cam abut against the first driven cam and the second driven cam, the first elastic member and the second elastic member are compressed, and wherein when the first carrying member and the second carrying member are in the unfolded state or the folded state, the first elastic member and the second elastic member are released correspondingly.

8. The foldable electronic device of claim 7, wherein the first axis, the first inner virtual axis, the first outer virtual axis, the second axis, the second inner virtual axis and the second outer virtual axis are parallel to each other.

9. The foldable electronic device of claim 8, wherein the first elastic member and the second elastic member are respectively a compression spring.

10. The foldable electronic device of claim 1, wherein the synchronization module further includes a first helical protrusion, a second helical protrusion, a first helical groove and a second helical groove, the first helical protrusion is matched and accommodated in the first helical groove, and the second helical protrusion is matched and accommodated in the second helical groove.

11. The foldable electronic device of claim 10, wherein the first helical groove is recessed in the first transmission member along a first helical direction, the second helical groove is recessed in the second transmission member along a second helical direction and corresponds to the first helical groove, and wherein the first helical protrusion and the second helical protrusion are respectively formed on two opposite surfaces of the synchronization slider body.

12. The foldable electronic device of claim 11, wherein the first helical direction is opposite to the second helical direction.

13. The foldable electronic device of claim 12, wherein the central base further includes a housing covering the body portion, wherein when the first panel body and the second panel body are in the unfolded state, the first drop plate and the second drop plate contact a top side of the housing, and wherein when the first panel body and the second panel body are in the folded state, the first drop plate and the second drop plate are away from the housing.

14. The foldable electronic device of claim 13, wherein the central base further includes a track groove formed through the track portion, and wherein the synchronization module further includes a limiting rib formed on the synchronization slider body, and the limiting rib is slidably accommodated in the track groove.
